(19) United States
(12) Patent Application Publication
(10) Pub. No.: US 2017/0087713 A1
(43) Pub. Date: Mar. 30, 2017

(54) Roof/Gutter Inspector

(71) Applicant: Jeffrey Marshall, Reading, MA (US)

(72) Inventor: Jeffrey Marshall, Reading, MA (US)

(21) Appl. No.: 15/274,657

(22) Filed: Sep. 23, 2016

Related U.S. Application Data
(60) Provisional application No. 62/222,925, filed on Sep. 24, 2015.

(51) Int. Cl. B25J 1/04; H04N 5/77; H04N 5/225; H04N 5/232; E04D 15/00; E04G 23/02

(52) U.S. Cl. CPC B25J 1/04; E04D 15/006; E04G 23/0281; H04N 5/2251; H04N 5/23203; H04N 5/772

(57) ABSTRACT

A cellular device assembly wherein the assembly has a mounting arrangement and an elongated, extendable support system. The cellular device assembly is used to inspect roofs for damage or gutters for clogs. A homeowner securely attaches his cellular device to the mounting arrangement and then attaches the mounting arrangement to the elongated, extendable support system. Then, the homeowner activates the video recording application on his cellular phone. Next, the homeowner may adjust the elongated, extendable support system to a desired height of his roof or gutters and record the condition of the roof and/or gutters. Once complete, the elongated, extendable support is retracted and the video footage is reviewed.

### CROSS REFERENCE TO RELATED APPLICATION

This application claims the benefit of and takes priority from U.S. Provisional Application Ser. No. 62/222,925 filed on Sep. 24, 2016, the contents of which are herein incorporated by reference.

### COPYRIGHT STATEMENT

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

### FIELD OF THE INVENTION

The present invention relates generally to a electronic device supports and methods of using, and more particularly an apparatus for holding a cellular device in order to investigate the current condition of a house's roof and/or gutter system.

### BACKGROUND OF THE INVENTION

Inspecting one's roof and gutter system is an important responsibility for all homeowners. Differing weather patterns can cause wear and tear on roofing materials. Extreme climate changes may also cause harm to a roof, as well as, snow, sleet, hail, and heavy rain. Necessary roof repairs may go unnoticed for long periods of time because homeowners are unable to inspect their roofs easily and efficiently.

Especially serious roof damage can occur with the formation of ice dams. Ice dams are formed by a complex interaction among the amount of heat loss from a house, snow cover, and outside temperatures. For an ice dam to form there must be snow on the roof and, simultaneously, higher portions of the roof's outside surface must be above 32° F. while lower surfaces are below 32° F. For a portion of the roof to be below 32° F., outside temperatures must also be below 32° F. When describing temperatures being above or below 32° F., usually these temperatures are an average temperature over sustained periods of time. Snow on a roof surface that is above 32° F. will melt. As water flows down the roof it reaches the portion of the roof that is below 32° F. and refreezes. The result: once the melted water refreezes it creates an ice dam.

Prevention of ice dams forming on roofs is a very important step for homeowners to consider every winter. One way to prevent ice dams is to remove snow from the roof. When heavy snowfall occurs, this task usually requires homeowners to climb atop their roofs and rake, broom, push, and shovel in order to remove the snow. This type of roof inspection can be disastrous because any person on a roof during the winter is risking serious injury and sometimes death. On top of it all, homeowners may risk climbing their roof to make an inspection, only to find that there are no problems. This result may deter them from making future inspections.

Gutter inspection is also an important homeowner responsibility. Gutter problems may occur over time because of a build up of dirt, leaves, etc. These materials accumulate and can clog the gutter preventing from the gutter from working properly. Gutters can also be the home to many different type of critters including chipmunks, squirrels, mice, and birds. These animals may build nests within the gutter—out of human sight—and also cause clogging.

Rainwater that flows from the roof is not able to drain from the gutter if the gutter is clogged. As a result, the water will then overflow at the edge of the gutter and there will be no controlled flow to direct the water to drains. Often times, the overflowing rainwater will run down the side of buildings and houses, which over time can lead to structural damage. Further, on days where there is heavy rain, overflowing gutters can cause roof damage, leaks, and potentially pull the gutter away from the roof. In order to avoid this, homeowners and building inspectors are required to inspect the gutters for any types of clogs and then clean the gutters if necessary.

Inspection of both the roof and gutters with an individual climbing up a ladder or scaffolding to take a look at the gutters. Inspecting the gutters in this fashion, especially to look through the long pipes for clogs within can be very complicated and dangerous especially for those who are inexperienced in climbing on ladders. Homeowners are either required to do the dangerous task themselves and risk potentially falling or hiring a company.

Cellular phones have developed throughout recent years to include numerous different functions. One of the more universal functions is the ability for the electronic device to not only act as a calling apparatus but also as a camera and video recorder. Because users seem to always carry their cellular phone, they always have access to a device that can take a quick video or picture. Recently though, persons with the camera function on their cellular phones wanted to be included in the photograph or video—thus, there have been numerous accessories created to allow a user to take action shots and videos of himself, as well as unusual angle shots, such as overhead shots. This type of photograph has been coined and known as a “selfie.”

With the development of the “selfie,” accessories have been created to help a user take a better photograph. The person who is using the cellular device may position the camera at arms-length and snap a photograph. This can prove to be difficult due to the body position and camera angle. With this issue, inventors have developed apparatuses whereby the cell phone user can readily take an image of himself by attaching the cellular phone to an elongated support, commonly known as a “selfie stick,” and snapping a picture.

As discussed above, all matters relating to the roof and gutters can be dangerous and the alternative of hiring a company can be very pricey. The present invention is based on an apparatus that will be safer and reduce the cost of inspecting roofs and gutters. Further, the present invention helps homeowners not have to risk scaling their roof to inspect for potential problems.

### SUMMARY OF THE INVENTION

The instant apparatus, as illustrated herein, is not anticipated, rendered obvious, or present in any of the prior art mechanisms, either alone or in any combination thereof. Therefore, it is an object of the instant system to provide a system, method, process and accompanying apparatuses for a roof and gutter inspection assembly.

It is an object of the present invention to provide an apparatus and method of using the apparatus whereby a user may inspect his roof and gutters safely.

It is yet another object of the present invention to provide a cellular device support system and methods of using the system.

More particularly, it is yet another object of the present invention to provide a cellular device assembly for inspecting roofs and gutters which comprises of a mounting arrangement with an elongated, extendable support. The elongated, extendable support includes a base assembly, whereby the user of the cellular phone may secure the cellular phone to the base assembly and, after setting the cellular phone to a video record setting, positioning the cellular phone around the roof and gutter area of a house and record and capture images of the conditions of the roof and gutter area for inspection.

In yet another object of the present invention, is to reduce the cost of inspecting roofs and gutters.

It is yet another object of the present invention to provide a cellular device support system that includes a portable elongated apparatus with a base assembly that securely holds a cellular device and is capable of inspecting roofs and gutters.

Yet another object of the present invention is to provide a cellular device assembly whereby the elongated extendable support is adjustable in length so that inspection can occur on high roofs and high-mounted gutters.

It is an object of the present invention to provide an apparatus and method of using the apparatus, wherein the apparatus is lightweight and easily maneuverable to inspect roofs, gutters, and the inside of gutter pipes.

Yet another object of the present invention is to provide a hand held elongated cellular device support which may be used to explore by camera hard-to-reach or unsafe areas on a roof or in a gutter.

It is a further object of the present invention to provide an apparatus of the type set forth above wherein the elongated support is an extensible support, which support may be manipulated between retracted and extended positions.

There has thus been outlined, rather broadly, the more important features of the versatile systems, apparatuses and accompany methods for a roof and gutter inspector assembly and method in order that the detailed description thereof that follows may be better understood, and in order that the present contribution to the art may be better appreciated. There are additional features of the system that will be described hereinafter and which will form the subject matter of the claims appended hereto.

In this respect, before explaining at least one embodiment of the process in detail, it is to be understood that the process is not limited in its application to the details of construction and to the arrangements of the components set forth in the following description or illustrated in the drawings. The process is capable of being utilized in other embodiments and of being practiced and carries out in various ways. Also, it is to be understood that the phraseology and terminology employed herein are for the purpose of description and should not be regarded as limiting.

These, together with other objects of the process, along with the various features of novelty, which characterize the process, are pointed out with particularity in the claims annexed to and forming a part of this disclosure.

### BRIEF DESCRIPTION OF THE DRAWINGS

FIG. 1A illustrates the front of the mounting arrangement of the cellular device assembly for inspecting roofs and gutters;

FIG. 1B illustrates the back of the mounting arrangement of the cellular device assembly for inspecting roofs and gutters;

FIG. 1C illustrates the right side of the mounting arrangement of the cellular device assembly for inspecting roofs and gutters;

FIG. 1D illustrates the left side of the mounting arrangement of the cellular device assembly for inspecting roofs and gutters;

FIG. 2 illustrates mounting arrangement of the cellular device assembly attached to an elongated, extendable support system;

FIG. 3 illustrates the mounting arrangement of the cellular device assembly with the elongated, extendable support system being used by a homeowner to inspect his gutters; and

FIG. 4 illustrates one embodiment of the present invention wherein the mounting arrangement of the cellular device assembly is attached to an ice concentration prevention mechanism.

### DETAILED DESCRIPTION OF THE SEVERAL EMBODIMENTS

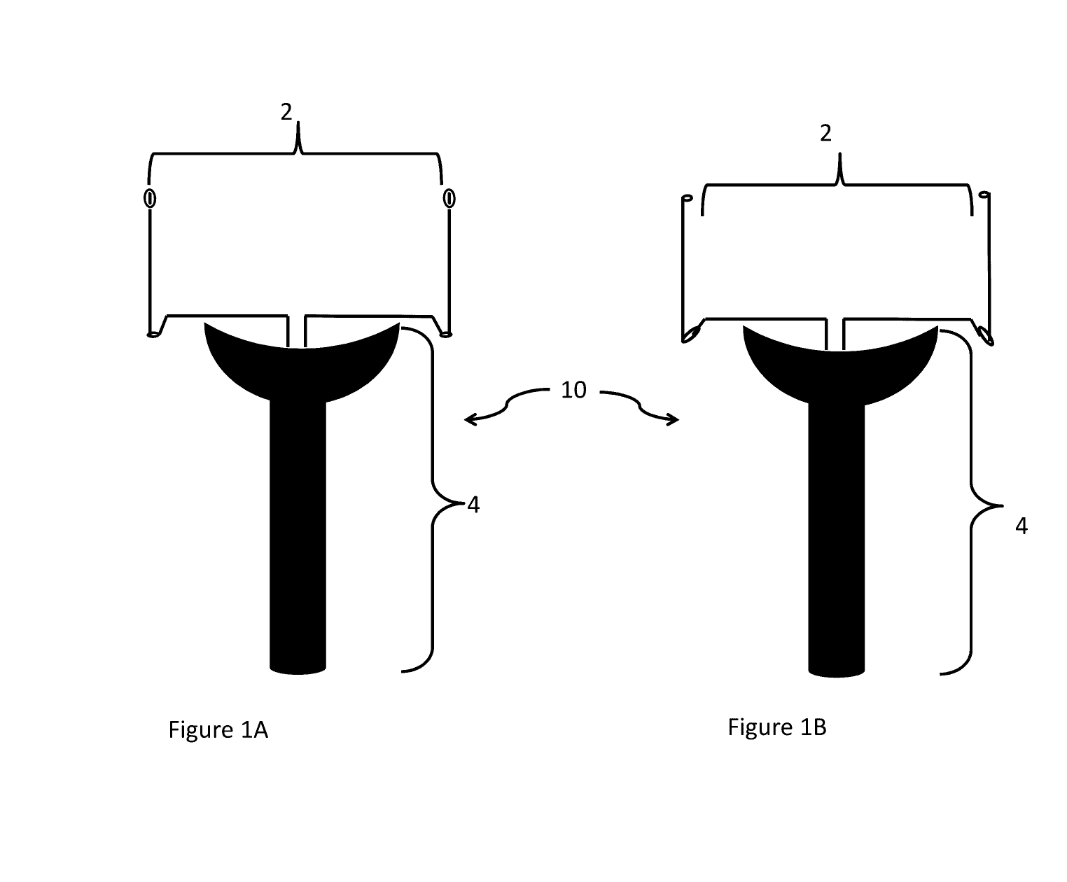

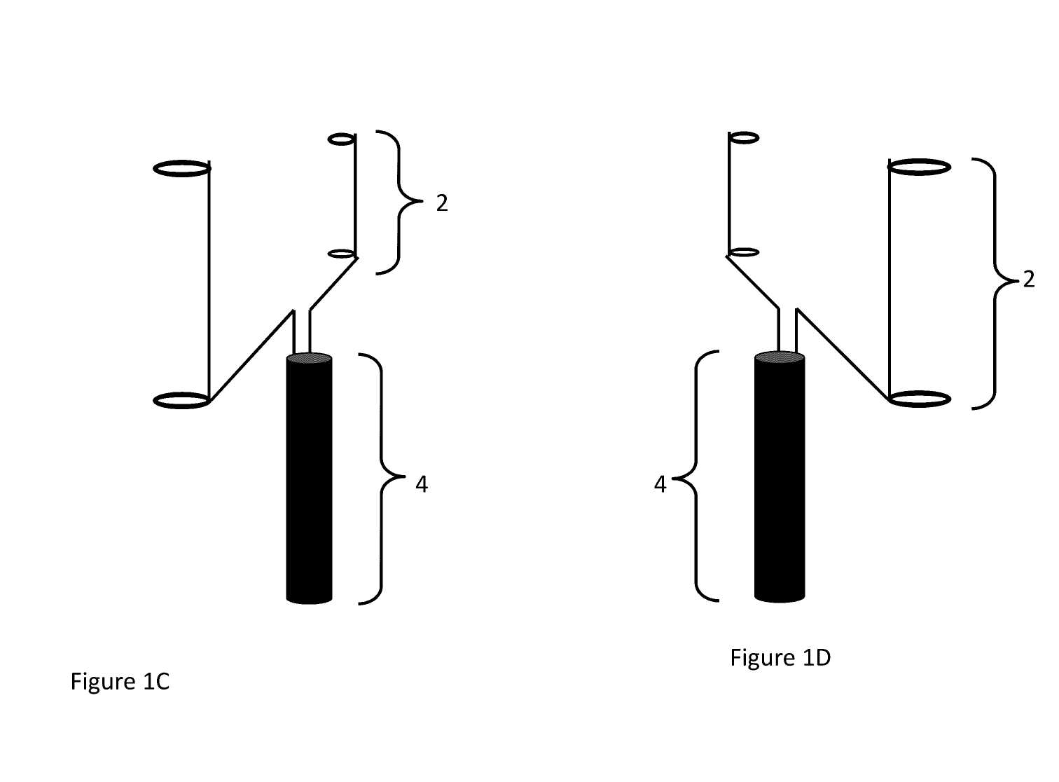

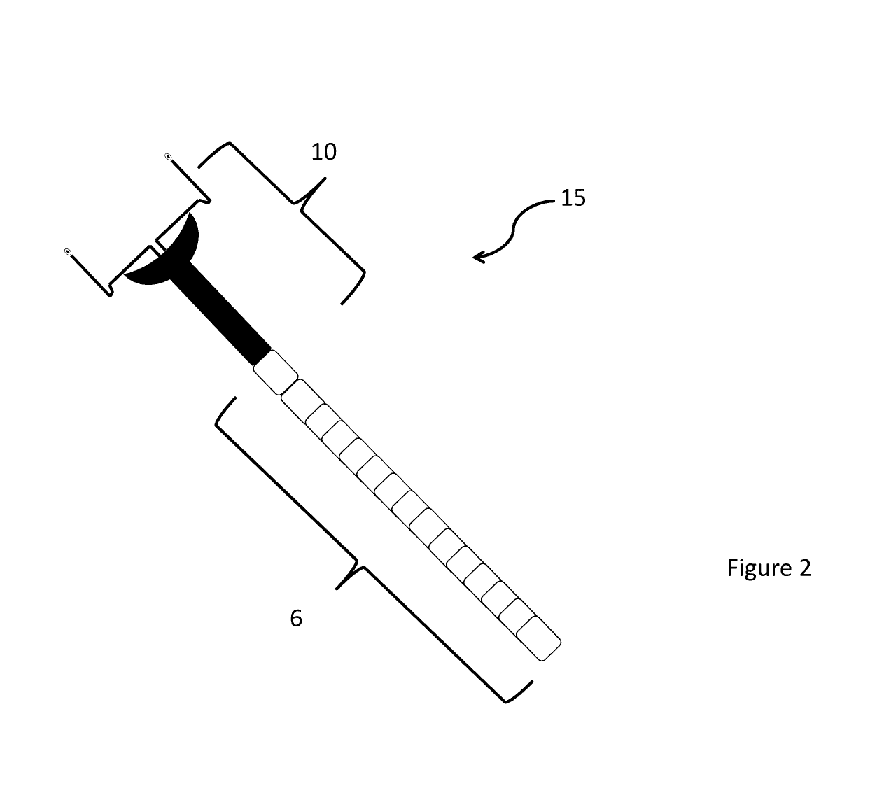

FIGS. 1A-1D depicts the mounting arrangement 10 of the cellular device assembly 15 for inspecting roofs and gutters. A user takes their cellular device and securely places it into a mounting arrangement head 2. The mounting arrangement is constructed from sturdy material like plastic, metal wiring, etc. In certain embodiments the mounting arrangement would vary in size depending on the cellular device version used by the homeowner. Once a cellular device is securely placed within the mounting arrangement head 2, the handle of the mounting arrangement 4, is securely attached to the elongated, extendable support system. FIGS. 1A-1D depict all different perspectives of the mounting arrangement of the cellular device assembly.

FIG. 2 depicts the mounting arrangement 10 of the cellular device assembly 15 attached to the elongated extendable support system 6, thus making up the entire cellular device assembly 15. The elongated extendable support system is adjustable and also made from a sturdy material like metal.

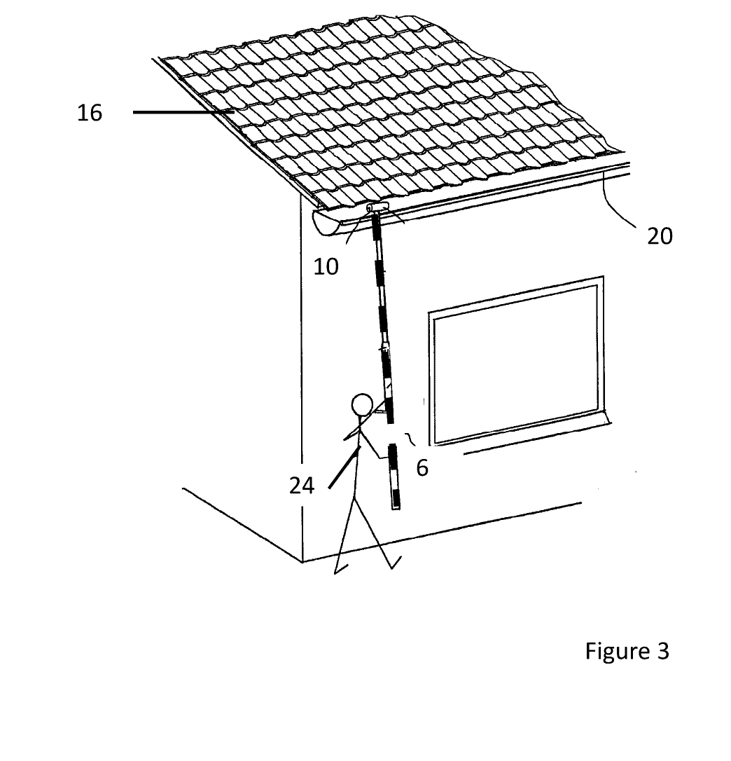

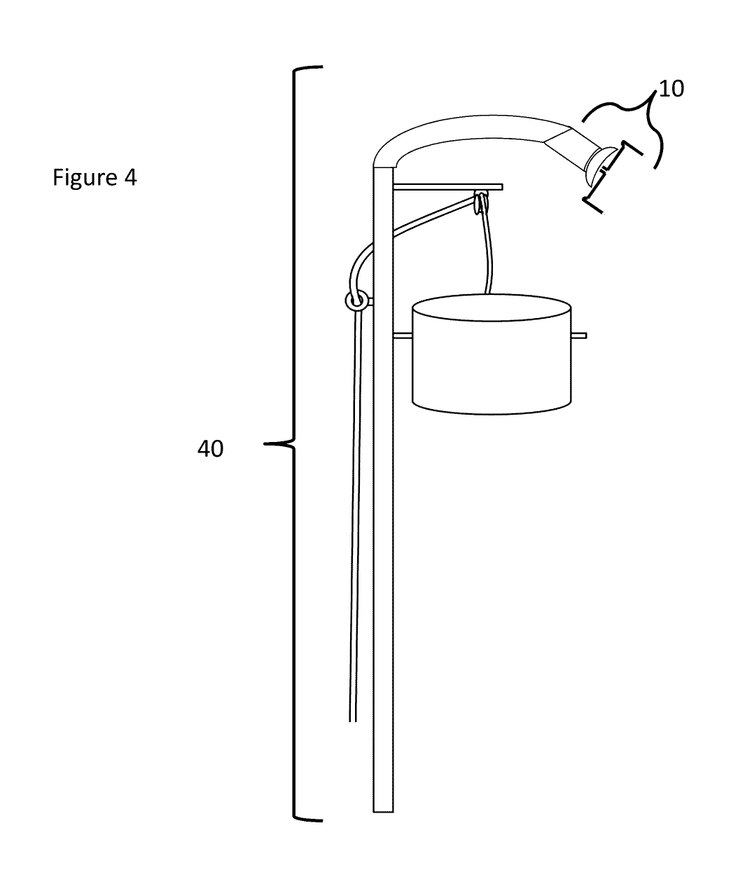

FIG. 3 depicts a homeowner 24 using the mounting arrangement 10 attached to the elongated, extendable support system 6 to inspect the gutters 20. Once the mounting arrangement 10 is attached to the elongated, extendable support system 6, the user wants to activate his cellular device to record video. While the cellular device is recording, the elongated extendable support system is adjusted to reach an appropriate height to inspect an area.

In another embodiment the elongated, extendable support system may be made out of a flexible material in order to be adjusted to investigate hard to reach places within the gutters.

In another embodiment, the cellular device assembly can be used to inspect for ice dams during the winter, in order to prevent major roof damage and leaking.

Once the user is done inspecting, he can adjust the elongated, extendable support system to ground level, remove his cell phone and review the video footage. From there, the homeowner can make decisions on whether gutters need to be unclogged or whether there is roof damage that needs to be fixed.

In another embodiment, the cellular device assembly 15 may be used to inspect a roof 16. By using the cellular device assembly, a homeowner can save time and money to investigate and inspect the condition of his roof and the condition of his gutters. Homeowners do not need to partake in dangerous methods like climbing ladders or scaffolds, walking on the roof. Further, homeowners do not need to risk injury inspecting their roofs in the conventional manner, only to find that the roofing materials are perfectly suitable.

The cellular device assembly is portable and easily maneuverable, allowing an inexpensive, efficient, and safer alternative for homeowners to routinely inspect their roofs and gutters.

FIG. 4 depicts a specific embodiment wherein the mounting arrangement 10 is attached to an ice concentration prevention mechanism 40. Another aspect to this embodiment includes a feedback screen (not shown) where a user's cellular device is able to wirelessly connect to the feedback screen and the recording and images are wireless transmitted to the feedback screen so that a user can view his work on a roof while utilizing the ice concentration prevention mechanism.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable sub combination.

Moreover, although features may be described above as acting in certain combinations and even initially claimed as such, one or more features from a claimed combination can in some cases be excised from the combination, and the claimed combination may be directed to a sub combination or variation of a sub combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system variants and components in the embodiments described above should not be understood as requiring such separation in all embodiments, and it should be understood that the described components and systems can generally be integrated together in a single software product or packaged into multiple software products.

Particular embodiments of the subject matter have been described. Other embodiments are within the scope of the invention. For example, the actions recited in the description can be performed in a different order and still achieve desirable results.

What is claimed is:

1. A cellular device assembly comprising:
a mounting arrangement; and
an elongated, extendable support system wherein the mounting arrangement attaches to the elongated, extendable support system.

2. The cellular device assembly of claim 1, wherein the mounting arrangement further comprises a mounting arrangement head and a mounting arrangement handle.

3. The cellular device assembly of claim 1, wherein the elongated, extendable support system is adjustable.

4. The cellular device assembly of claim 1, wherein the elongated, extendable support system is flexible.

5. The cellular device assembly of claim 1, wherein a cellular device is secured to the mounting arrangement head.

6. The cellular device assembly of claim 1, where the mounting arrangement head is made from a sturdy material selected from a group consisting of plastic, and metal.

7. The cellular device assembly of claim 1, where the mounting arrangement handle is made from a plastic material.

8. The cellular device assembly of claim 1, wherein the mounting arrangement head varies in size.

9. A method for using the cellular device assembly of claim 1, comprising the steps of:
attaching a cellular device to a mounting arrangement securely;
attaching the mounting arrangement to an elongated, extendable support system;
activating a video recording system on the cellular device;
adjusting the elongated, extendable support system to a desired height;
inspecting a roof for damages;
inspecting a gutter system for clogs;
retracting the extendable support system; and
reviewing the video recording.
